(19) United States
(12) Patent Application Publication
(10) Pub. No.: US 2011/0095535 A1
(43) Pub. Date: Apr. 28, 2011

(54) Electrical generating device with potential energy of water or fluid

(76) Inventors: Fu Hung Ho, Taichung Hsien (TW); Ming Jung Kao, Taichung Hsien (TW)

(21) Appl. No.: 12/589,583

(22) Filed: Oct. 26, 2009

(51) Int. Cl. F03B 13/06

(52) U.S. Cl. 290/54

(57) ABSTRACT

An electrical generating device includes a higher gear and a lower gear rotatably mounted between a higher water tower and a lower water reservoir, a chain engaged with the gears and having a number of plates, the water tower includes an outlet tube directed to the plates for supplying the water to move the plates downwardly and to rotate the chain and the gears, an electric generator is coupled to the higher gear for being actuated to generate an electrical energy, and one or more ram water pumps are used for pumping the water from the water reservoir upwardly into the water tower without electrical energy, the higher gear is adjustable to different rotational speeds with an adjustable magnetic device.

### BACKGROUND OF THE INVENTION

1. Field of the Invention

The present invention relates to an electrical generating device, and more particularly to an electrical generating device for generating electrical energy with the potential energy of the water supported on a high position and for allowing the electric generating device to be available and to be used for the house buildings and/or for the house families.

2. Description of the Prior Art

Typical hydraulic electrical generating devices comprise a structure for utilizing or employing the water flowing or the hydraulic energy to generate the electrical energy. However, the water flowing or the hydraulic energy is not available for normal house buildings, such that the typical electrical generating devices are not available for the normal house buildings, and may not be provided for generating the electrical energy for the normal house families.

For our house buildings, one or more water towers are required to be disposed and supported on the higher position of the house buildings, and one or more water pumps are required to be provided for pumping the water upwardly to the water towers. However, a large amount of electrical energy is required to be provided for energizing and actuating or operating the water pumps, and the highly supported water may not be used to generate the electrical energy.

The present invention has arisen to mitigate and/or obviate the afore-described disadvantages of the conventional electrical generating devices.

### SUMMARY OF THE INVENTION

The primary objective of the present invention is to provide an electrical generating device for generating electrical energy with the potential energy of the water supported on a high position.

The other objective of the present invention is to provide an electrical generating device for allowing the electric generating device to be available and to be used for the house buildings and/or for the house families.

In accordance with one aspect of the invention, there is provided an electrical generating device comprising a support including a water reservoir for receiving and containing water, a water tower disposed on the support and located above the water reservoir for receiving the water, and including an outlet tube, a hydraulic energy converting device including a higher gear rotatably mounted below the water tower, a lower gear rotatably mounted and supported above the water reservoir, a chain engaged with the higher and the lower gears and having a number of plates attached along the chain, the outlet tube of the water tower being directed to the plates for supplying the water to move the plates downwardly and to rotate the chain and the higher and the lower gears, an electric generator coupled to the higher gear for allowing the electric generator to be rotated and driven by the higher gear and the chain, in order to generate an electrical energy with the potential energy of the water supported on a high position, and at least one ram water pump provided for pumping the water from the water reservoir upwardly into the water tower without electrical energy, for allowing the electric generating device to be available and to be used for the house buildings and/or for the house families.

A change gear box is further provided and coupled to the higher gear and the electric generators. An adjustable magnetic device is further provided and mounted between the higher gear and the change gear box for adjusting a rotational speed of the higher gear.

The support includes a water receptacle disposed below the water reservoir and having a discharge port for discharging the water downwardly into a water container which is disposed below the water receptacle.

The water receptacle is provided for receiving a water flowing out from the ram water pump. One or more water elevating devices are disposed between the water reservoir and the water container for elevating the water upwardly from the water container into the water reservoir.

The water elevating device includes a higher pinion, a lower pinion, a chain engaged with the higher and the lower pinions and having a number of water scooping members mounted along the chain.

The water elevating device includes an elevating tube disposed between the water reservoir and the water container for receiving a portion of the chain and the water scooping members. The higher pinion is coupled to the lower gear for being rotated and driven by the lower gear.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front plan schematic view of an electrical generating device in accordance with the present invention;

FIG. 2 is an enlarged partial front plan schematic view of the electrical generating device;

FIG. 3 is another enlarged partial front plan schematic view similar to FIG. 2, illustrating the operation of the electrical generating device;

FIG. 4 is a partial side plan schematic view of the electrical generating device; and

FIG. 5 is an enlarged partial side plan schematic view illustrating the operation of the electrical generating device.

### DETAILED DESCRIPTION OF THE PREFERRED EMBODIMENT

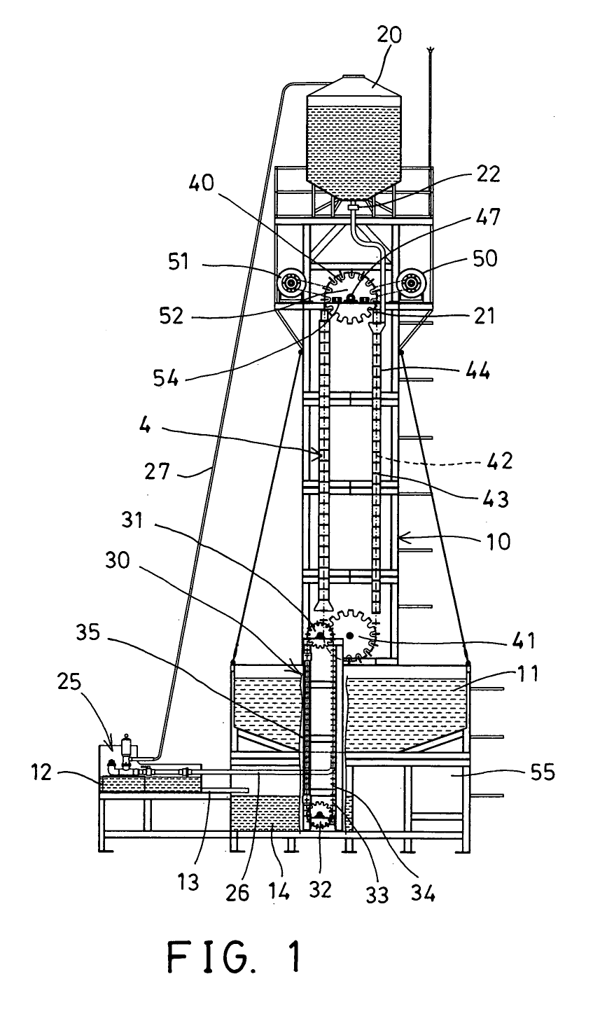

Referring to the drawings, and initially to FIGS. 1-4, an electrical generating device in accordance with the present invention comprises a column or machine body or support 10 including a water reservoir 11 disposed and supported on the middle or lower position of the support 10 for receiving or containing the water or the other fluid therein, and including a water receptacle 12 disposed and supported slightly below the water reservoir 11 for receiving or containing the water or the other fluid therein and having a discharge port 13 for discharging or supplying the water or the fluid downwardly into a lower water container 14 which is further disposed and supported slightly below the water receptacle 12.

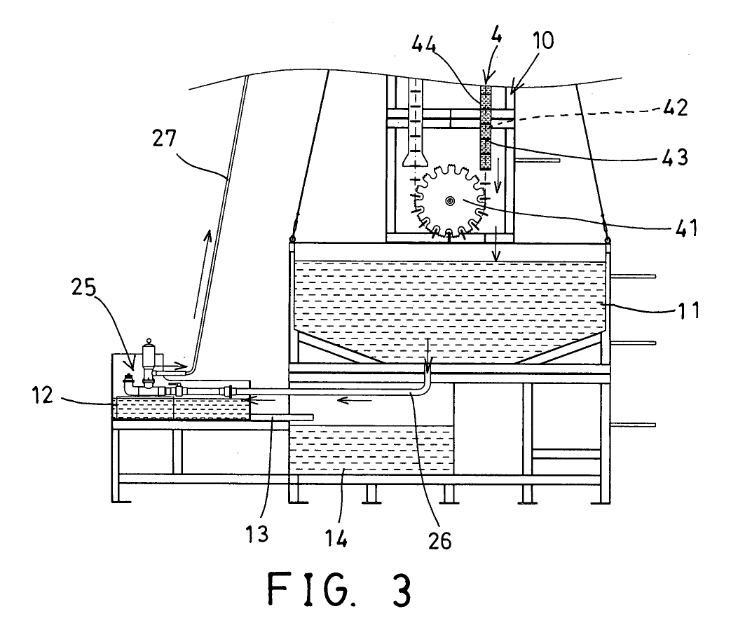

A water tower 20 is disposed or mounted and supported on the higher position of the support 10 and located above the water reservoir 11, and includes an outlet tube 21, and an electrical control valve 22 attached or mounted and coupled to the outlet tube 21 for controlling the water or the fluid to selectively flow out of the water tower 20, one or more (such as two) water pumps 25, such as the ram water pumps 25 are provided and attached or mounted for pumping or forcing the water or the fluid upwardly to the water tower 20 without the electrical energy. For example, the ram water pumps 25 include an inlet pipe 26 disposed and coupled to the water reservoir 11 (FIG. 3) for receiving the water or the fluid from the water reservoir 11, and include an outlet pipe 27 disposed and directed or coupled to the water tower 20 for selectively directing or supplying the water or the fluid into the water tower 20.

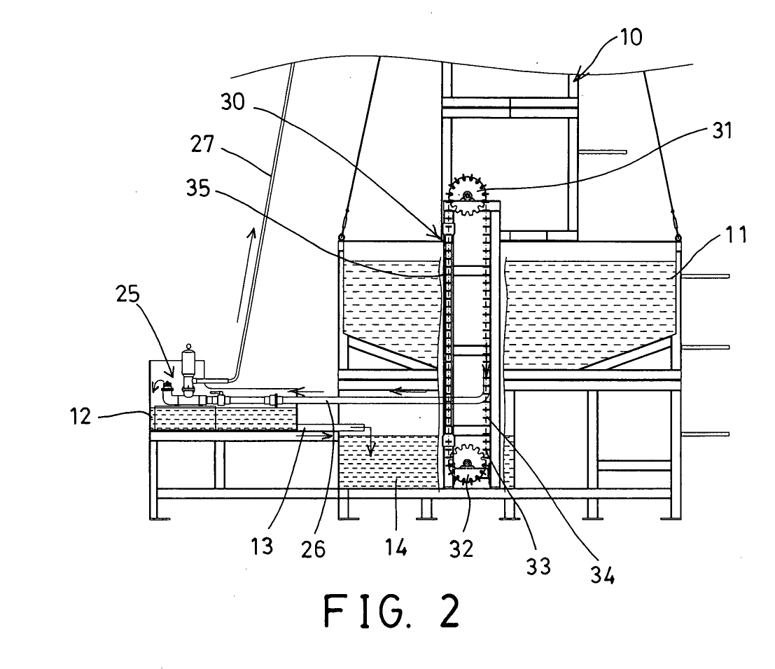

The above-described ram water pumps 25 are typical and will not be described in further details, and an amount of the water or the fluid may flow out of the ram water pumps 25 while in use or when the ram water pumps 25 are energized or operated, and the water or the fluid from the ram water pumps 25 may flow into the water receptacle 12, and may then flow into the water container 14 which is further disposed and supported slightly below the water receptacle 12. One or more (such as two, FIG. 2) water elevating devices 30 may further be provided and disposed or coupled between the water reservoir 11 and the water container 14 for elevating or supplying the water or the fluid upwardly into the water reservoir 11, and the water or the fluid received or contained in the water tower 20 may be provided for generating an electrical energy with the potential energy of the water or the fluid that is disposed or supported on a higher position, which will be described in further details hereinafter.

For example, as shown in FIGS. 1-2, and 4, the water elevating devices 30 each include a higher pinion 31 and a lower pinion 32, a chain 33 disposed and engaged with the pinions 31, 32 and having a number of water drawing or scooping members 34 disposed and attached or mounted along the chain 33, and/or an elevating tube 35 disposed or mounted between the water reservoir 11 and the water container 14 for receiving a portion of the chain 33 and the water drawing or scooping members 34 and for elevating or supplying the water or the fluid upwardly from the water container 14 into the water reservoir 11; or the water or the fluid may be directly elevated or supplied upwardly into the water reservoir 11 with the water drawing or scooping members 34 only, and without the elevating tube 35.

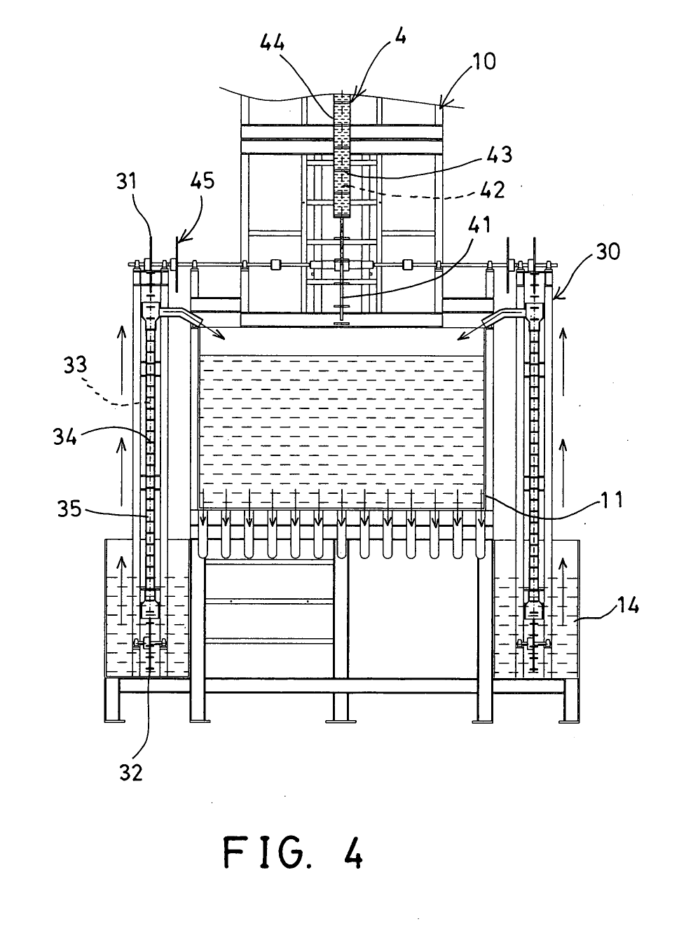

The electrical generating device in accordance with the present invention further comprises a hydraulic energy converting device 4 including a higher gear 40 pivotally or rotatably attached or mounted and supported slightly below the water tower 20, and a lower gear 41 pivotally or rotatably attached or mounted and supported slightly above the water reservoir 11, or disposed beside or between the pinions 31 (FIG. 4) of the two water elevating devices 30, and a chain 42 disposed and engaged with the gears 40, 41 and having a number of water drawing or scooping members or plates 43 disposed and attached or mounted along the chain 42, and/or a guiding tube 44 disposed or mounted between the water tower 20 and the water reservoir 11 for receiving and guiding a portion of the chain 42 and the water drawing or scooping members or plates 43 and for preventing the chain 42 and the water drawing or scooping members or plates 43 from vibrating or from moving sidewise.

In operation, as shown in FIG. 1, the water flowing out of the water tower 20 and flowing through the outlet tube 21 is directed or supplied into the upper portion of the guiding tube 44, and the weight or the potential energy of the water or the fluid may move the water drawing or scooping members or plates 43 downwardly and may move or rotate the chain 42, and may then rotate or drive the gears 40, 41, the lower gear 41 may be directly meshed or engaged with the higher pinion 31, or may be coupled to the higher pinion 31 with a coupling device 45 (FIG. 4) in order to rotate or drive the pinions 31, 32 and the chain 33 and so as to elevate or supply the water or the fluid upwardly from the water container 14 into the water reservoir 11 with the water drawing or scooping members 34 and with the weight or the potential energy of the water or the fluid supported on a higher position.

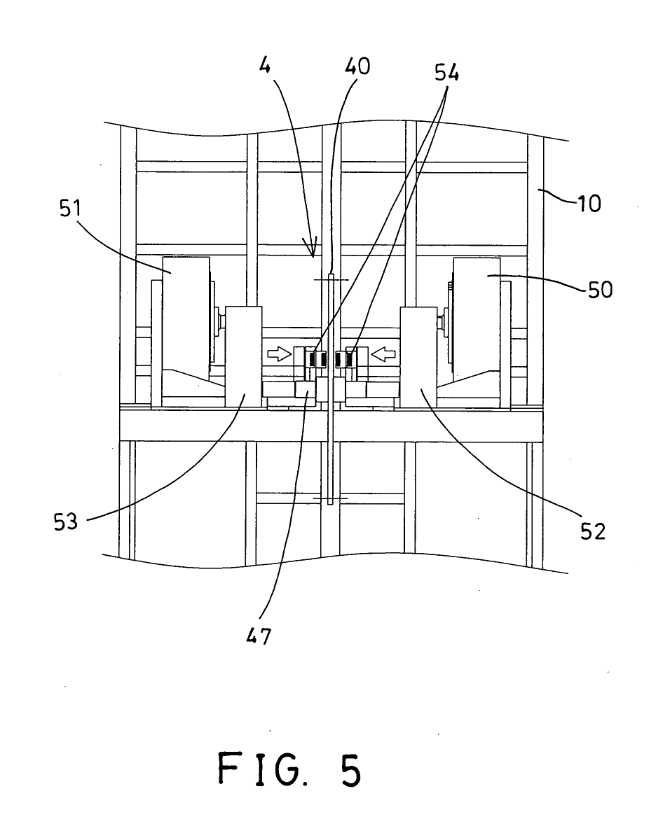

As shown in FIGS. 1 and 5, the higher gear 40 is disposed and attached or mounted on a spindle 47, and one or more (such as two) electric generators 50, 51 are disposed beside the spindle 47 and directly meshed or engaged with the spindle 47, or coupled to the spindle 47 with reduction gearings, change gears or change gear boxes 52, 53, or directly coupled to the higher gear 40 for allowing the electric generators 50, 51 to be rotated or driven by the higher gear 40 and the chain 42 of the hydraulic energy converting device 4, in order to generate the electrical energy. One or more (such as two, FIG. 5) adjustable or slidable magnetic devices 54 are disposed or mounted between the higher gear 40 and the electric generators 50, 51 or the change gear boxes 52, 53 and slidable along or relative to the spindle 47 for adjusting the distance between the higher gear 40 and the magnetic devices 54 and for adjusting the rotational speed of the higher gear 40.

For example, the rotational speed of the higher gear 40 is greater when the magnetic devices 54 are disposed or mounted and located farther away from the higher gear 40, at this moment, the change gear boxes 52, 53 or the electric generators 50, 51 may be rotated or driven by the higher gear 40 with a greater rotational speed. On the contrary, when the magnetic devices 54 are disposed or mounted or adjusted and located closer to the higher gear 40, the magnetic devices 54 may apply a relatively greater retarding force onto the higher gear 40 and the rotational speed of the higher gear 40 will be selectively lowered or reduced or decreased, and the change gear boxes 52, 53 or the electric generators 50, 51 may be rotated or driven by the higher gear 40 with a relatively decreased rotational speed but may be rotated or driven by the higher gear 40 with a relatively greater driving torque.

As shown in FIG. 1, a control device 55 may further be provided and coupled to the electric generators 50, 51 and/or the change gear boxes 52, 53 for controlling the electric generators 50, 51 and/or the change gear boxes 52, 53 and/or for storing or controlling the electrical energy generated by the electric generators 50, 51, and for suitably supplying the electrical energy to energize and actuate or operate the other electrical facilities or appliances. It is to be noted that the water pumps 25 may be provided for pumping the water upwardly to the water tower 20 without the electrical energy, and the gears 40, 41 and the chain 42 and the plates 43 may be moved or actuated with the weight or the potential energy of the water or the fluid that is disposed or supported on a higher position in order to suitably actuate or operate the electric generators 50, 51 to generate the electrical energy.

It is further to be noted that the ram water pumps 25 may also be provided and directly attached or mounted in the water reservoir 11 for directly pumping or forcing the water or the fluid to flow upwardly from the water reservoir 11 to the water tower 20 without the electrical energy and without the water receptacle 12 and the water container 14 and the water elevating devices 30.

Accordingly, the electrical generating device in accordance with the present invention may be provided for generating electrical energy with the potential energy of the water supported on a high position and for allowing the electric generating device to be available and to be used for the house buildings or house families.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electrical generating device comprising:
a support including a water reservoir for receiving and containing water,
a water tower disposed on said support and located above said water reservoir for receiving the water, and including an outlet tube,
a hydraulic energy converting device including a higher gear rotatably mounted below said water tower, a lower gear rotatably mounted and supported above said water reservoir, a chain engaged with said higher and said lower gears and having a plurality of plates attached along said chain, said outlet tube of said water tower being directed to said plates for supplying the water to move said plates downwardly and to rotate said chain and said higher and said lower gears,
an electric generator coupled to said higher gear for allowing said electric generator to be rotated and driven by said higher gear and said chain, in order to generate an electrical energy, and
at least one ram water pump provided for pumping the water from said water reservoir upwardly into said water tower without electrical energy.

2. The electrical generating device as claimed in claim 1, wherein a change gear box is coupled to said higher gear and said electric generators.

3. The electrical generating device as claimed in claim 2, wherein an adjustable magnetic device is mounted between said higher gear and said change gear box for adjusting a rotational speed of said higher gear.

4. The electrical generating device as claimed in claim 1, wherein said support includes a water receptacle disposed below said water reservoir and having a discharge port for discharging said water downwardly into a water container which is disposed below said water receptacle.

5. The electrical generating device as claimed in claim 4, wherein said water receptacle is provided for receiving a water flowing out from said at least one ram water pump.

6. The electrical generating device as claimed in claim 4, wherein at least one water elevating device is disposed between said water reservoir and said water container for elevating the water upwardly from said water container into said water reservoir.

7. The electrical generating device as claimed in claim 6, wherein said at least one water elevating device includes a higher pinion, a lower pinion, a chain engaged with said higher and said lower pinions and having a plurality of water scooping members mounted along said chain.

8. The electrical generating device as claimed in claim 7, wherein said at least one water elevating device includes an elevating tube disposed between said water reservoir and said water container for receiving a portion of said chain and said water scooping members.

9. The electrical generating device as claimed in claim 7, wherein said higher pinion is coupled to said lower gear for being rotated and driven by said lower gear.
